(19) United States
(12) Patent Application Publication
(10) Pub. No.: US 2009/0038464 A1
(43) Pub. Date: Feb. 12, 2009

(54) Adjustment assembly for a drum

(76) Inventor: Kuo-Chang Chen, Taichung Hsien (TW)

Correspondence Address: COOPER & DUNHAM, LLP, 30 Rockefeller Plaza, 20th Floor, NEW YORK, NY, 10112, US

(21) Appl. No.: 11/891,266

(22) Filed: Aug. 9, 2007

(51) Int. Cl. G10D 13/02

(52) U.S. Cl. 84/411 R

(57) ABSTRACT

An adjustment assembly for a drum includes two bodies, two hollow nuts, a connector and two mounting bolts. Each body has a connecting hole. The connecting hole is defined through the body and has a keyed countersink defined in the connecting hole. Each hollow nut is mounted in the connecting hole of a corresponding body and is allowed epicyclic motion in the connecting hole without rotating. The connector is mounted securely in the connecting holes of the bodies. Each mounting bolt is mounted in a corresponding hollow nut and has a flange. Therefore, the mounting bolts can be aligned with and mounted respectively in the connecting nuts easily because of the allowed movement of the connecting nuts.

### BACKGROUND OF THE INVENTION

1. Field of Invention

The present invention relates to a drum, and more particularly to an adjustment assembly for a drum that can be attached or detached easily and conveniently.

2. Description of the Related Art

With reference to FIGS. 4 and 5, a conventional drum comprises a body (70), two rings (80), two membranes (81) and multiple conventional adjustment assemblies (90). The body (70) is a hollow cylinder and has two ends. The rings (80) are mounted respectively on the ends of the body (70) and each ring (70) has multiple fastening holes corresponding respectively to the fastening holes of the other ring (70). The membranes (81) are stretched respectively over the ends of the body (70) and attached respectively to the rings (80). The conventional adjustment assemblies (90) are mounted in the fastening holes of the rings (80) to adjust a distance between the rings (80) and tension of each membrane (81).

Each conventional adjustment assembly (80) comprises two bodies (91), a connecting tube (92), two fastening bolts (93) and two mounting bolts (94). The bodies (91) are connected to the body (70) of the drum and each body (91) has a bottom surface, at least one exterior surface, a threaded hole (911) and a through hole (912). The threaded hole (91 1) is defined in the bottom surface. The through hole (912) is defined through the exterior surface, communicates with the threaded hole (911) and corresponds to one of the fastening holes of the rings (80). The connecting tube (92) has two ends, a connecting hole (921) and two inner threads. The ends of the connecting tube (92) are mounted securely and respectively in the through holes (912) of the bodies (91). The connecting hole (921) is defined longitudinally through the connecting tube (92) and has an inner surface. The inner threads are formed respectively in the inner surface of the connecting tube (92). The fastening bolts (93) are mounted in the threaded holes (911) and engage the connecting tube (92). The mounting bolts (94) are mounted respectively through the corresponding fastening holes of the rings (80) and in the inner threads of the connecting tube (92). The distance between the rings (80) can be adjusted by turning the mounting bolts (94) thereby adjusting the tensions of the membranes (81).

However, when the corresponding fastening holes in the rings (80) do not align precisely with each other and both of the mounting bolts (94) cannot be mounted until further adjustment is made, so the mounting bolts (94) are not mounted easily in the inner threads in the connecting tube (92). Adjustments to the tensions of the membranes (81) required for optimal performance under various conditions is also inconvenient. Additionally, when a mounting bolt (94) is mounted misaligned with the inner thread, the mounting bolt (94) and the inner thread may be damaged or worn off requiring their replacement, or leading to their detachment.

To overcome the shortcomings, the present invention provides an adjustment assembly for a drum to mitigate or obviate the aforementioned problems.

### SUMMARY OF THE INVENTION

The primary objective of the present invention is to provide an adjustment assembly for a drum that can be mounted and detached easily and conveniently.

An adjustment assembly for a drum in accordance with the present invention comprises at least one body, at least one hollow nut, a connector and at least one mounting bolt. Each one of the at least one body has a connecting hole. The connecting hole is defined through the body and has a keyed countersink defined in the connecting hole.

Each one of the at least one hollow nut is mounted in the connecting hole of a corresponding body and has a hollow shaft, a hollow head and a threaded hole. The hollow shaft is mounted in the connecting hole and is smaller than the connecting hole. The hollow head is mounted in the keyed countersink of the connecting hole and is allowed epicyclic motion in the connecting hole without rotation. The threaded hole is defined through the hollow nut.

The connector is mounted securely in the connecting hole of the at least one body.

Each one of the at least one mounting bolt is mounted in a corresponding hollow nut and has a rotating head, a threaded shaft and a flange formed between the rotating head and the threaded shaft. Therefore, the mounting bolt can be aligned with and mounted respectively in a hollow nut easily because of the allowed movement of the hollow nut in the connecting hole of a corresponding body.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a drum with multiple adjustment assemblies in accordance with the present invention;

FIG. 2 is an enlarged, exploded perspective view of the adjustment assembly for a drum in FIG. 1;

FIG. 3 is a side view in partial section of the adjustment assembly for a drum in FIG. 1;

FIG. 4 is a perspective view of a drum with multiple conventional adjustment assemblies in accordance with the prior art; and

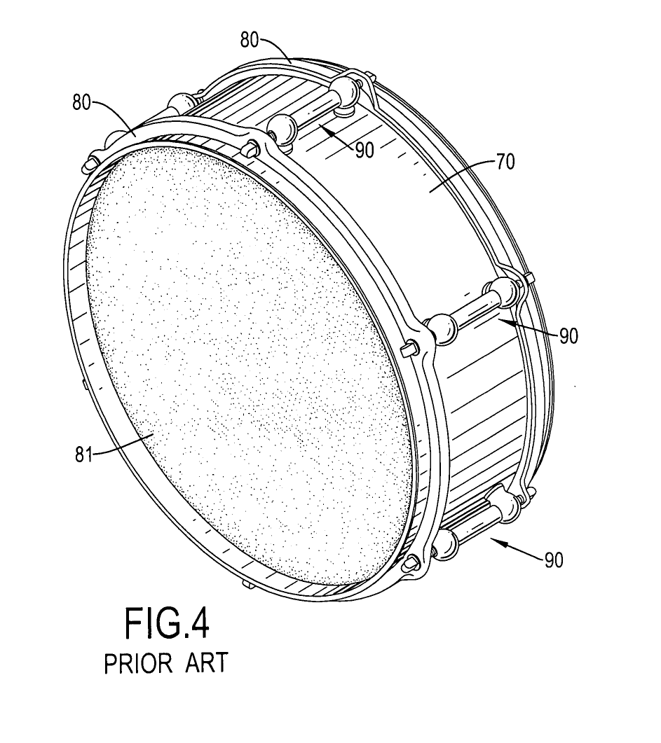

FIG. 5 is a side view in partial section of the conventional adjustment assembly for a drum in FIG. 4.

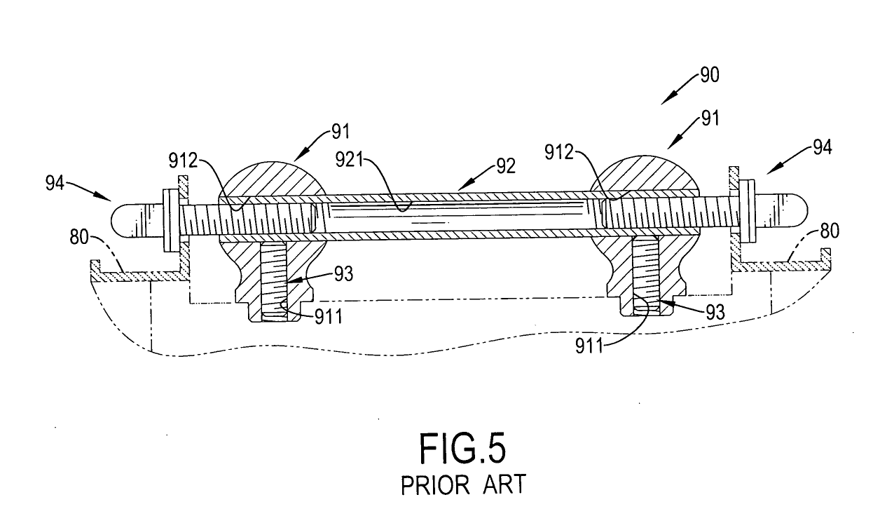

### DETAILED DESCRIPTION OF THE INVENTION

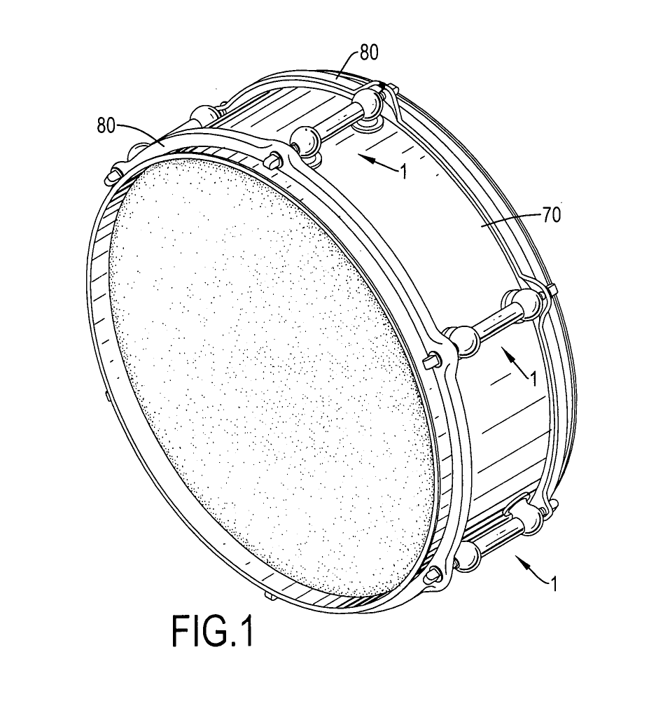

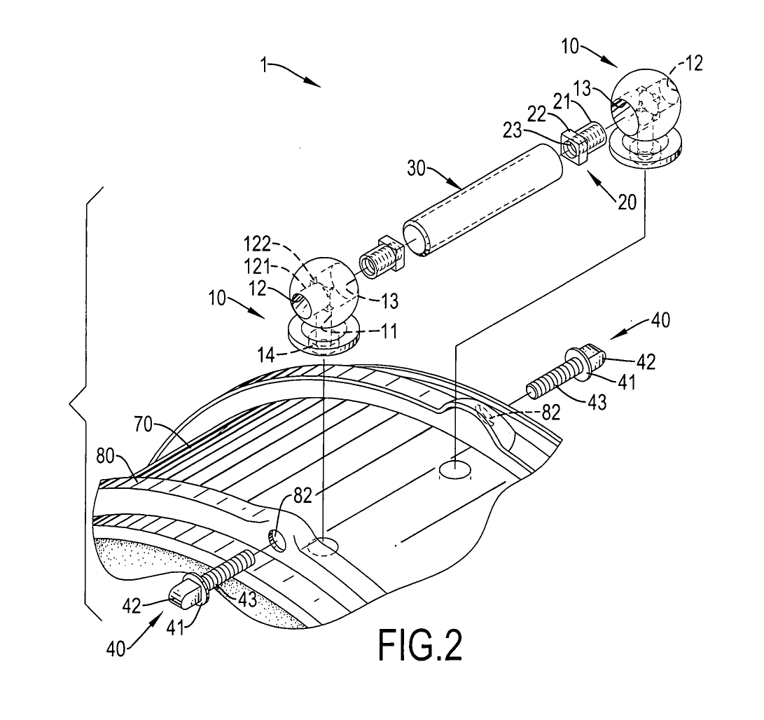

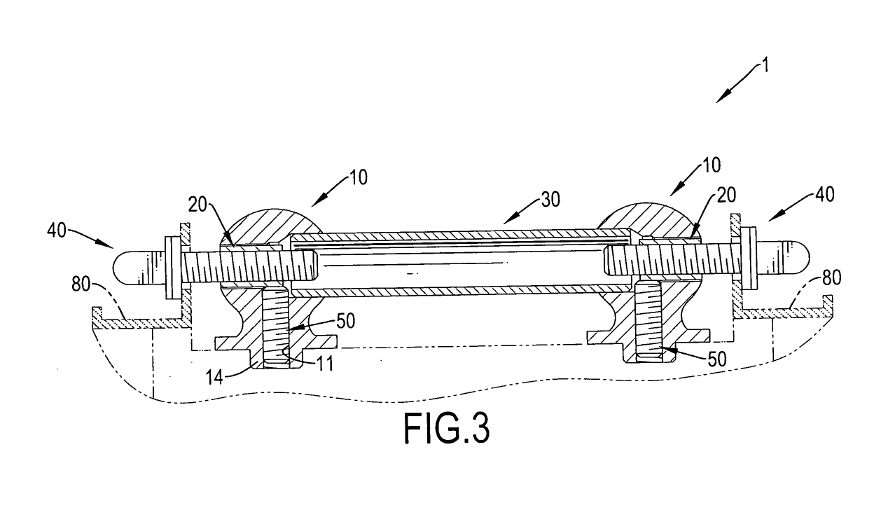

With reference to FIGS. 1 to 3, an adjustment assembly (1) in accordance with the present invention is mounted on a drum having a body (70), at least one membrane and at least one ring (80), each ring (80) having multiple fastening holes (82). The adjustment assembly (1) comprises at least one body (10), at least one hollow nut (20), a connector (30), at least one mounting bolt (40) and at least one fastening bolt (50).

Each one of the at least body (10) is attached to the body (70) of the drum and has a bottom surface, a connecting hole (12), an optional stud (14) and an optional threaded hole (11). The connecting hole (12) is defined through the body (10), may be circular and comprises a keyed countersink (122). The keyed countersink (122) may be square, hexagonal or such like to prevent rotation and is larger than the connecting hole. The stud (14) is formed on the bottom surface of the body (10) and is mounted in the body (70) of the drum. The threaded hole (11) is defined through the bottom surface of the body (10), may be through the stud (14) and communicates with the connecting hole (12).

Each one of the at least one hollow nut (20) is mounted in the connecting hole (12) of a corresponding body (10) and has a hollow shaft (21), a hollow head (22) and a threaded hole (23). The hollow shaft (21) is mounted slidably in the connecting hole (12) and is smaller than the connecting hole (12). The hollow head (22) corresponds to and is loosely mounted slidably in the keyed countersink (122) of the connecting hole (12). Therefore the hollow nut (20) is allowed slight epicyclic motion within the connecting hole (12) without rotation. The threaded hole (23) is defined through the hollow nut (20).

The connector (30) is mounted securely in the connecting hole (12) of the at least one body (10) and is connected, directly or indirectly, to the rings (80) of the drum. When the adjustment assembly only has one body (10), the connector (30) is mounted in the body (10) and is connected directly to a corresponding ring (80).

Each one of the at least one mounting bolt (40) is mounted through a fastening hole (82) of a corresponding ring (80) and in a corresponding hollow nut (20) and has a rotating head (42), a threaded shaft (43) and a flange (41). The flange (41) is formed between the rotating head (42) and the threaded shaft (43) and abuts the corresponding ring (80). When the rotating head (42) is turned relative to the hollow nut (20), the ring (80) is pushed closer or released further from the body (10), thereby altering tension of the membranes. Each one of the at least one fastening bolt (50) is mounted in the threaded hole (11) in a body (10).

Preferably the adjustment assembly (1) comprises two bodies (10), two hollow nuts (20), two mounting bolts (40) and two fastening bolts (50). The hollow nuts (20) are mounted respectively in the connecting holes (12) in the bodies (10). The mounting bolts (40) are mounted respectively in the hollow nuts (40). The connector (30) is tubular and has two ends securely mounted respectively in the connecting holes (12) of the bodies (10). The fastening bolts (50) are mounted respectively in the threaded holes (11) of the bodies (10) to fasten the hollow nuts.

When one mounting bolt (40) is mounted in one of the hollow nuts (20), the other mounting bolt (40) can still be aligned with and mounted easily in the other hollow nut (20) due to the epicyclic motion of the hollow nut (20) allowed by the connecting hole (12). Furthermore, the hollow nuts (20) and the mounting bolts (40) engage properly preventing damage and excess wear, so the adjustment assembly can be attached or detached conveniently.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

1. An adjustment assembly for a drum comprising
at least one body and each one of the at least one body having a bottom surface;
a connecting hole being defined through the body and having a keyed countersink being larger than the connecting hole;
at least one hollow nut and each one of the at least one hollow nut being mounted in the connecting hole of a corresponding body and having
a hollow shaft being mounted slidably in the connecting hole and being smaller than the connecting hole;
a hollow head corresponding to and being mounted loosely in the keyed countersink of the connecting hole of the corresponding body; and
a threaded hole being defined through the hollow nut;
a connector being mounted securely in the connecting hole of the at least one body; and
at least one mounting bolt and each one of the at least one mounting bolt being mounted respectively in the at least one hollow nut and having
a rotating head
a threaded shaft; and
a flange being formed between the rotating head and the threaded shaft.

2. The adjustment assembly for a drum as claimed in claim 1, wherein the adjustment assembly comprises
two bodies;
two connecting nuts being mounted respectively in the connecting holes in the bodies; and
two mounting bolts being mounted respectively in the connecting nuts.

3. The adjustment assembly for a drum as claimed in claim 2, wherein
the connector is tubular and has two ends securely mounted respectively in the connecting holes in the bodies.

4. The adjustment assembly for a drum as claimed in claim 3, wherein
the connecting hole of each body is circular; and
the keyed countersink of the connecting hole in each body is square.

5. The adjustment assembly for a drum as claimed in claim 4, wherein
each body further has a stud formed on the bottom surface of the body.

6. The adjustment assembly for a drum as claimed in claim 5, wherein
each body further has a threaded hole defined through the bottom surface of the body and the stud and communicating with the connecting hole; and
the adjustment assembly further comprises two fastening bolts mounted respectively in the threaded holes of the bodies.

7. The adjustment assembly for a drum as claimed in claim 1, wherein
each one of the at least one body further has a threaded hole defined through the bottom surface of the body and communicating with the connecting hole; and
the adjustment assembly further comprises at least one fastening bolts mounted respectively in the threaded hole of the at least one body.

8. The adjustment assembly for a drum as claimed in claim 1, wherein
the connecting hole in each one of the at least one body is circular; and
the keyed countersink of the connecting hole in each one of the at least one body is square.

9. The adjustment assembly for a drum as claimed in claim 1, wherein
each one of the at least one body further has a stud formed on the bottom surface of the body.

10. The adjustment assembly for a drum as claimed in claim 9, wherein
each one of the at least one body further has a threaded hole defined through the bottom surface of the body and the stud and communicating with the connecting hole; and
the adjustment assembly further comprises at least one fastening bolt mounted respectively in the threaded holes of the at least one body.
